(19) United States
(12) Patent Application Publication
(10) Pub. No.: US 2016/0298907 A1
(43) Pub. Date: Oct. 13, 2016

(54) METHOD FOR DETERMINING THE STATE OF THE TAP OF A METALLURGICAL VESSEL IN PARTICULAR

(71) Applicant: REFRACTORY INTELLECTUAL PROPERTY GMBH & CO. KG, Wien (AT)

(72) Inventors: Gregor LAMMER, Wien (AT); Karl-Michael ZETTL, Wien (AT); Christoph JANDL, Linz (AT)

(73) Assignee: Refrectory Intellectual Property GmbH & Co. KG, Wien (AT)

(21) Appl. No.: 14/777,770

(22) PCT Filed: Mar. 7, 2014
(86) PCT No.: PCT/EP2014/054473

§ 371 Date: Sep. 17, 2015

(30) Foreign Application Priority Data
Apr. 12, 2013 (EP) 13163565.8
Sep. 12, 2013 (EP) 13184161.1

(51) Int. Cl. F27D 21/00; F27D 3/15

(52) U.S. Cl. CPC F27D 21/0021; F27D 21/0014; F27D 21/0035; F27D 3/1509

(57) ABSTRACT

The invention relates to a method for determining the state of the tap of a vessel (10) containing molten metal in particular. In the process, data of the fire-resistant lining of the tap (20), such as materials, wall thickness, type of installation, etc., is detected or measured and evaluated. Said data is then collected and stored in a data structure. A calculation model is generated from the data structure on the basis of at least some of the measured or ascertained data or parameters, and said data or parameters are evaluated by means of the calculation model using calculations and subsequent analyses. Thus, in addition to measurements, related or integral ascertaining processes and subsequent analyses can also be carried out for a metallurgical vessel in order to ascertain the current state of the fire-resistant lining of the tap of the vessel after the vessel has been used.

The invention relates to a method for determining the state of the tap of a metallurgical vessel in particular according to the preamble to claim 1.

Calculation methods exist for the construction of the refractory lining of the tap and of the vessel, in particular of metallurgical crucibles, wherein ascertained data or empirical values are converted into mathematical models. Since with these mathematical models the effective wear mechanisms for the uses of the metallurgical vessels can not be detected sufficiently accurately or be taken into consideration, the possibilities for mathematically determining the state of the refractory linings and of the tap and the maintenance work of the lining are very restricted, i.e. decisions regarding the period of use of the refractory lining of a vessel or its tap, for example of a converter, must still be taken manually.

In a method according to publication WO-A-03/081157 for measuring the residual thickness of the refractory lining in the wall and/or base area of a metallurgical vessel, e.g. of an arc furnace, the measured data ascertained are used for the subsequent repair of the areas of wear that have been identified. The measuring unit is brought here on a manipulator serving to repair the lining into a measuring position over or inside the metallurgical vessel and the residual thickness of the lining is then measured in its wall and/or base area. By comparing with a current profile of the lining measured at the start of the furnace campaign its wear is ascertained, on the basis of which the refractory lining can then be repaired. With this method, however, comprehensive ascertainment of the vessel lining is not possible either.

According to publication WO-A-2007/107242 a method for determining the wall thickness or the wear of the lining of a metallurgical crucible with a scanner system for contactlessly sensing the lining surface with determination of the position and orientation of the scanner system and assignment to the position of the crucible by detecting spatially fixed reference points is disclosed. A perpendicular reference system is used here and the tilts of two axes in relation to a horizontal plane are measured by means of tilt sensors. The data measured by the scanner can be transformed into a perpendicular coordinate system and automated measurement of the respective current state of the lining of the crucible is thus possible.

On the basis of these known calculation methods or measuring methods it is the object of the present invention to devise a method of the type mentioned at the start by means of which the service life of the refractory lining of the tap of a metallurgical vessel and the process in its own right can be optimised and manual decisions for this purpose are reduced or practically eliminated.

According to the invention this object is achieved by the features of claim 1.

The method according to the invention makes provision such that data of a respective vessel are collected and stored in a data structure, and a calculation model is generated from all of the measured and ascertained data or parameters, in particular of the refractory lining of the tap, by means of which these data or parameters are evaluated by means of calculations and subsequent analyses.

With this method according to the invention, for a metallurgical vessel one can ascertain not only measurements in order to identify the current state of the refractory lining of the tap of the vessel after the vessel has been used, but related or integral ascertaining processes and subsequent analyses can also be carried out from which optimisations are achieved both in relation to this refractory lining of the tap and optionally to the entire process sequence of the molten mass poured into the vessel and treated within the latter.

Additional advantageous details of this method within the framework of the invention are defined in the dependent claims.

Exemplary embodiments as well as additional advantages of the invention are described in more detail below by means of a drawing. This shows:

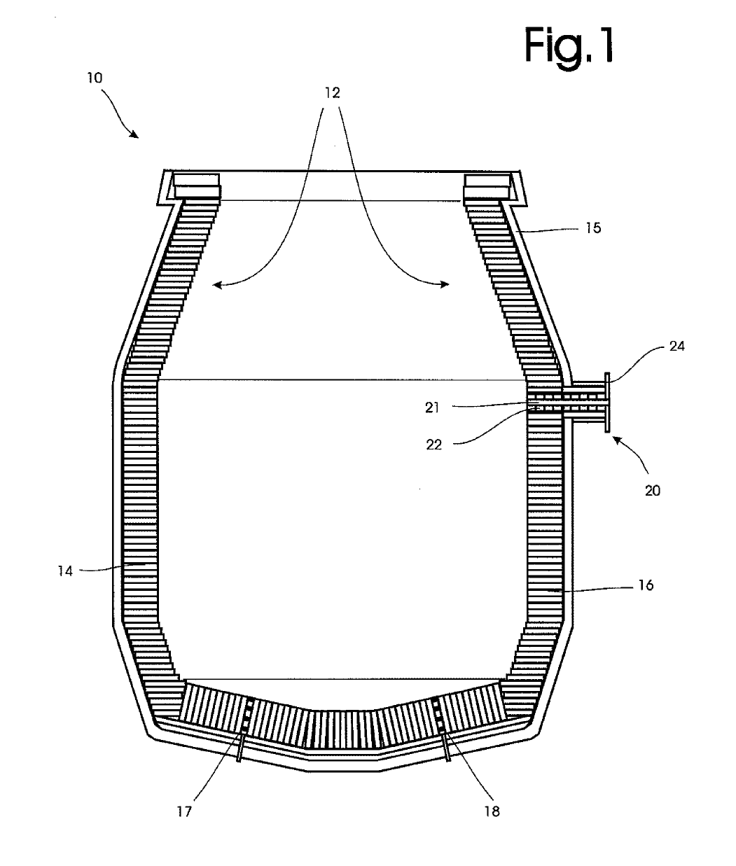

FIG. 1 is a diagrammatic longitudinal section of a metallurgical vessel with a tap.

The method relates in particular to metallurgical vessels, one such vessel 10 being shown in section in FIG. 1 as an exemplary embodiment. In this instance the vessel is a converter 10, known in its own right, for the production of steel. This converter 10 consists essentially of a metal housing 15, a refractory lining 12, a tap 20 and gas purging plugs 17, 18 which can be coupled to a gas supply (not detailed).

The molten metal which is poured into this converter 10 during operation is treated metallurgically, for example by a blowing process which will not be described in any more detail. Generally a number of these converters 10 are used at the same time in a steel works to produce steel and data are to be recorded for each of these converters.

This tap 20 is assigned to the upper side region of the converter 10 and is used to discharge the molten metal after being treated. This tap 20 is composed of a tap channel 21, sleeve-shaped tap blocks 22 forming the latter and a metal discharge port 24. Needless to say, this tap can also be configured differently to the one that is illustrated.

In principle, the method can be used for different metallurgical vessels, such as for example for electric furnaces, blast furnaces, steel ladles, vessels in the field of non-ferrous metals such as aluminium melting furnaces, copper anode furnaces or the like.

The method is also characterised in that it can likewise be used for a variety of different vessels. Thus, for example, the refractory linings of the taps of all converters and optionally ladles in operation can be determined, wherein the same molten mass is first of all treated in a converter and is then poured into steel ladles.

First of all, all of the data for each tap 20 of the converter 10, sub-divided into groups, are collected and stored in a data structure.

In order to measure the wear as a group, this initially takes place on the new refractory lining where the specified dimensions of the tap blocks 22 are known. In addition, the materials and material properties of the tap blocks 22 used and of any mortar or the like used are recorded.

For the additional group identified as production data recording takes place during the period of use of the respective converter 10, such as the amount of molten mass, the temperature, the composition of the molten mass or the slag and its thickness, tapping times, temperature profile, treatment time and/or metallurgical parameters such as particular additions to the molten mass. Depending on the type of converter, only some or all of the aforementioned production data are recorded.

In particular, the invention is characterised in that the tapping time is primarily used for the recurring calculations and analyses made by the calculation model. With the tapping time measurements one can draw very reliable conclusions regarding wear and additional factors such as changes with increasing usage time of the refractory tap blocks.

After using the converter 10 a measurement of the inside diameter of the refractory lining in the tap 20 is advantageously taken in section. It is sufficient here if the wall thicknesses of the lining 12 are measured after a number of tappings.

Other process parameters, such as the manner of pouring or tapping the molten metal into or out of the crucible can then be ascertained.

According to the invention, a calculation model is generated from at least some of the measured and ascertained data or parameters, by means of which these data or parameters are evaluated by calculations and subsequent analyses.

By means of this calculation model generated according to the invention the maximum period of use, the wall thicknesses, the materials and/or the maintenance data of the refractory lining of the tap 20 or, conversely, the process sequences for the treatment of the molten mass can be optimised. From these analyses a decision can sometimes be made here regarding further use of the refractory lining of the tap 20 with or without repairs. One no longer requires, or if so only to a limited extent, manual experiential interpretation of the period of use of the refractory lining of the tap 20 and of the other values to be determined, such as wall thicknesses, material selection etc.

Advantageously the tap 20 is sub-divided into a number of sections, for example into an inlet in the container interior, into a number of sections in the tap channel 21 and into an outlet on the discharge port 24.

The sections in the tap 20 are evaluated individually or independently of one another with the calculation model. The advantage of this is that the different loads of the lining can be correspondingly taken into account.

Before or during generation of the calculation model the data are checked for plausibility after being recorded and if there is a lack or an anomaly of one or more values, the latter are respectively corrected or deleted. After preferably individually checking the data, the latter are stored as an assembled, valid set of data.

Advantageously, a reduced number is selected from the measured or ascertained data or parameters for the recurring calculations or analyses, this taking place dependently upon empirical values or by calculation methods. This selection of measured or ascertained data or parameters for the recurring calculations or analyses takes place by means of algorithms, for example a random feature selection.

The data are used for statistical purposes or for later recording for the reconstruction of production errors or similar.

As another advantage of the invention, the calculation model is adapted from the measurements of the refractory lining of the tap 20 after a number of tappings by means of an analysis, for example a regression analysis, by means of which the wear can be calculated or simulated taking into account the collected and structured data. This adapted calculation model is also especially suitable for use for the purposes of testing in order to test or simulate process sequences or to make specific changes.

The invention is sufficiently displayed by the exemplary embodiment described above. Needless to say it could also be realised by other variations.

1. A method for determining the state of the tap of a metallurgical vessel in particular, wherein data of the refractory lining of the tap (20), such as materials, wall thickness, type of installation and others are detected or measured and evaluated, characterised in that the following measured or established data of each vessel (10) are collected and stored in a data structure, namely
the initial refractory construction of at least the refractory lining of the tap (20), such as materials, material properties, wall thicknesses of the tap blocks (22) and/or injected materials as maintenance data;
production data during use, such as amount of molten mass, temperature, composition of the molten mass or the slag and its thickness, tapping times, temperature profiles, treatment times and/or metallurgical parameters;
additional process parameters such as the manner of pouring or tapping the molten metal into or out of the vessel;
that a calculation model is generated from at least some of the measured or ascertained data or parameters, by means of which these data or parameters are evaluated by means of calculations and subsequent analyses.

2. The method according to claim 1, characterised in that the tapping time is primarily taken into account for the recurring calculations or analyses by the calculation model, this taking place dependently upon empirical values or by calculation methods.

3. The method according to claim 1, further comprising:
checking the data for plausibility after being recorded of the data, and
when there is a lack or an anomaly of one or more values of the data, correcting the lack of one or more values of the data or deleting the anomaly of one or more values of the data.

4. The method according to claim 1, further comprising, after preferably individually checking the data, storing the checked data as an assembled, valid set of data.

5. The method according to claim 1, further comprising selecting a reduced number is selected from the measured or ascertained data or parameters for the recurring calculations or analyses dependent upon empirical values or by calculation methods.

6. The method according to claim 5, wherein the selection of measured or ascertained data or parameters for the recurring calculations or analyses takes place by means of algorithms, one of the algorithms being a random feature selection.

7. The method according to claim 5, further comprising using the data for statistical purposes or for later recording of data.

8. The method according to claim 1, wherein a decision is made regarding further use with or without repairs of the refractory lining of the tap by means of this generated calculation model.

9. The method according to claim 1, further comprising adapting the calculation model from the measurements of the tapping times of the molten mass from the vessel by means of an analysis, by means of which the wear can be calculated taking into account the collected and structured data.

10. The method according to claim 9, further comprising using the model for purposes of testing, in order to test or simulate process sequences from the model and in order to make specific changes in actual operation on this basis.

11. The method according to claim 1, wherein this tap is composed of a tap channel and of sleeve-shaped tap blocks forming the tap channel and made of refractory material.

12. The method according to claim 9, wherein the analysis is a regression analysis.

13. The method according to claim 2, further comprising:
checking the data for plausibility after being recorded of the data, and
when there is a lack or an anomaly of one or more values of the data, correcting the lack of one or more values of the data or deleting the anomaly of one or more values of the data.

14. The method according to claim 13, further comprising, after preferably individually checking the data, storing the checked data as an assembled, valid set of data.

15. The method according to claim 13, further comprising selecting a reduced number from the measured or ascertained data or parameters for the recurring calculations or analyses dependent upon empirical values or by calculation methods.

16. The method according to claim 2, further comprising, after preferably individually checking the data, storing the checked data as an assembled, valid set of data.

17. The method according to claim 2, further comprising selecting a reduced number from the measured or ascertained data or parameters for the recurring calculations or analyses dependent upon empirical values or by calculation methods.

18. The method according to claim 3, further comprising, after preferably individually checking the data, storing the checked data as an assembled, valid set of data.

19. The method according to claim 3, further comprising selecting a reduced number from the measured or ascertained data or parameters for the recurring calculations or analyses dependent upon empirical values or by calculation methods.

20. The method according to claim 2, wherein this tap comprises a tap channel and sleeve-shaped tap blocks forming the tap channel and made of refractory material.
